(19) United States
(12) Patent Application Publication
(10) Pub. No.: US 2016/0217483 A1
(43) Pub. Date: Jul. 28, 2016

(54) SYSTEM AND METHOD FOR ELECTRONICALLY RENEWING A CODE IN PERSONALIZED MEDIA

(71) Applicant: AUTOGRAPHY LLC, ST. PETERSBURG, FL (US)

(72) Inventors: Thomas J. Waters, St. Petersburg, FL (US); Robert N. Barrett, St. Petersburg, FL (US)

(21) Appl. No.: 15/006,238

(22) Filed: Jan. 26, 2016

Related U.S. Application Data
(60) Provisional application No. 62/107,754, filed on Jan. 26, 2015.

(51) Int. Cl. G06Q 30/02

(52) U.S. Cl. CPC G06Q 30/0211; G06Q 30/0222

(57) ABSTRACT

Delivering personalized digital media is a way for artists, athletes, authors, and other celebrity figures to build a relationship with fans. The personalized digital media can be stored locally, in the cloud, or on a fan-specified device. The personalized digital media can also contain a one-time use code (e.g., an embedded electronic discount) for free giveaways, discounts, or similar loyalty program devices. The systems and methods herein demonstrate a way to ‘re-charge’ such a program by allowing the artist, at their discretion, to re-activate, renew, and/or replace the previously used (or unused) one-time code with another one to reward the fan for their continued interest in the artist's work. While consumers have always been able to add credits, cash, or similar mechanisms to reward cards for retailers, the disclosed systems and methods are designed specifically for artist-controlled rewards program and works only with personalized digital media.

### CROSS-REFERENCE TO RELATED APPLICATION

This application claims priority to U.S. Provisional Patent Application No. 62/107,754 filed on Jan. 26, 2015, the contents of which are incorporated by reference herein.

### TECHNICAL FIELD

The present invention relates generally to the field of digital media and electronic rewards, and more particularly, to systems and methods for selectively renewing an electronic rewards code in a user's previously provided personalized digital media, the renewed code being subsequently redeemable at a vendor.

### BRIEF SUMMARY

Disclosed are systems and methods that allow, for example, a celebrity, author, musician, athlete, or public entity (collectively “artist”) to reward his or her fans (users of the systems and methods) who continue to follow the artist over time. In certain aspects, the artist previously provided personalized digital content to the fan (a signed ebook, photograph, or other digital media) that contained a unique code providing a discount for retail purchases (merchandise, concert passes, athletic event tickets, etc.). The systems and methods allow the artist to renew the previously provided discount code to the original media as a reward for the fan's continued interest. These systems and methods advantageously prevent the artist from diluting the value of personalized digital content while concurrently rewarding the fan (user) by reactivating, renewing, or replacing the unique code on the original personalized digital media, which may be subsequently redeemed at a predetermined vendor.

By renewing the code the artist can reward the fan who continues to listen to the artist's music, attends the athlete's games, or follows the actor's tv/movie appearances. Because digital media does not deteriorate over time the personalized media will maintain its original condition, and by receiving this renewed reward, the fan will be re-engaged with the artist even after an extended time when they receive notification that their personalized digital media from a year earlier has now been enhanced with a new tangible value outside the sentimental value.

Disclosed are systems and methods of renewing, re-activating, and/or replacing an embedded electronic discount code within personalized digital media for redeeming at a vendor, the method including: (a) previously providing a user with personalized digital media having an embedded electronic discount code for redeeming at the vendor that was subsequently redeemed at the vendor in exchange for merchandise, wherein the personalized digital media includes at least one of a digital autograph, a personalized digital written message, a personalized audio recording, or a personalized video recording generated by a celebrity, a musician, an athlete, an author or any combination thereof having the electronic discount code embedded therein; (b) after step (a), monitoring digital activities by the user to determine participation by the user in events associated with the celebrity, the musician, the athlete, the author or any combination thereof; (c) providing a predetermined threshold for renewing the embedded electronic discount code within the personalized digital media for user participation in the events of step (b); (d) determining at predetermined time intervals whether the user met or surpassed the predetermined threshold for renewing the embedded electronic discount code within the personalized digital media of step (c); and (e) upon determining that the predetermined threshold for renewing the embedded electronic discount code was met or surpassed, automatically renewing the electronic discount code within the personalized digital media and providing the user with notification that the embedded electronic discount code has been renewed and may be redeemed at the vendor. In certain aspects, the systems and methods further comprise redeeming the electronic discount code at the vendor. In certain aspects, a third party vendor associated with and/or employed by the celebrity, musician, athlete, author or any combination can monitor the digital activities by the user and subsequently determine whether the user has met or surpassed the predetermined threshold and subsequently renew, replace, and/or re-activate the user's discount code. In this aspect, the third party vendor can also provide the celebrity, musician, athlete, author or any combination with reports either in real-time or at predetermined time intervals providing statistical analysis of the user demographics (i.e., age, geographic location, event attendance frequency, weekly/monthly/yearly expenditures of the user associated with the celebrity, musician, athlete, author or any combination) thereby allowing the celebrity, musician, athlete, author or any combination to better target users and encourage receipt of these renew, re-activated, and/or replace embedded discount codes.

In certain aspects, the embedded electronic discount code is visually displayed in the personalized digital media.

In certain aspects, the embedded electronic discount code is hidden in the personalized digital media.

In certain aspects, the embedded electronic discount code is at least one selected from the group consisting of a general bar code, a proprietary bar code, a quick response code, an audio signal, or any combination thereof.

In certain aspects, the vendor is an online retailer or brick and mortar retailer.

In certain aspects, the embedded electronic discount code is for purchasing digital media, physical merchandise, or a combination thereof.

In certain aspects, the personalized digital media having an embedded electronic discount code was communicated from a database associated with the celebrity, the musician, the athlete, the author or any combination thereof to a user's personal media device selected from the group consisting of a laptop, a tablet, or a smartphone.

In certain aspects, during step (b), the database monitors user activity by communicating with the user's personal media device to subsequently determine whether the predetermined threshold for renewing the embedded electronic discount count was met or surpassed. The events associated with the celebrity, the musician, the athlete, the author or any combination thereof can include online events or live events at a specific location that are not online. In certain aspects, the events associated with the musician, the athlete, the author or any combination thereof comprise online events, live events at a specific location, or a combination thereof Furthermore, examples of predetermined thresholds of steps (c) and (d) include, but are not limited to, a musician who rewards a fan for attending multiple shows in a row on a tour. Such a fan (user) might attend concerts in several cities, wherein the artist rewards their loyalty and increased spending in attending multiple events over a short time period. Alternatively, an author might reward a new fan who initially purchases the fourth book in a series at a book signing, who subsequently purchases the prior three books published previously. The fan, having purchased the entire series, could be offered a discount or giveaway for the upcoming fifth book to be published in the future. In yet another example, a professional athlete who is traded from one team to another might offer fans who received autographed digital memorabilia a discount to purchase themed merchandise featuring his new team. This allows the athlete to retain fans over multiple team moves throughout the course of his or her career.

In certain aspects, the personalized digital media includes a certificate of authenticity. The certificate of authenticity includes, in certain aspects, authenticity verification of the digital autograph or personalized digital written message of the generated by the celebrity, a musician, an athlete, an author or any combination thereof in which the digital autograph or personalized digital written message must achieve at least a 90% confidence level based on an X,Y array coordinates including a statistical comparison of velocity between coordinates and relative position of points between coordinates when compared to reference samples of the celebrity, musician, athlete, author or any combination thereof, or the personalized audio recording or personalized video recording must achieve at least a 90% confidence level based on amplitude and frequency and/or facial recognition when compared to reference samples of the celebrity, musician, athlete, author or any combination thereof. In certain aspects, each of these confidence levels must achieve a 95% confidence level, preferably, a 95% confidence level, and more preferably a 99% confidence level. For example, the personalized digital media is a personalized video recording that must achieve at least a 99% confidence level based on amplitude and frequency and facial recognition when compared to reference samples of the celebrity, musician, athlete, author or any combination when verifying authenticity before embedding the unique discount code in the personalized digital media.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is an exemplary depiction of the systems and method for adding, renewing, and/or replacing a previously used embedded electronic discount code within personalized digital media; and

FIG. 2 is another exemplary depiction of the systems and method for adding, renewing, and/or replacing a previously used embedded electronic discount code within personalized digital media.

### DETAILED DESCRIPTION

The present invention will now be described more fully hereinafter with reference to the accompanying drawings in which exemplary embodiments of the invention are shown. In particular, the present invention is described below with reference to block diagrams and operational illustrations of methods, systems, and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Furthermore, the embodiments of methods presented are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently. The invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Generally, in terms of hardware architecture for the electronic devices disclosed below, computing device includes a processor, a memory, and one or more input and/or output (I/O) devices (or peripherals) that are communicatively coupled via a local interface. Local interface may be one or more buses or other wired or wireless connections, as is known in the art. Local interface may have additional elements, which are omitted for simplicity, such as controllers, buffers (caches), drivers, transmitters, and receivers to facilitate external communications with other like or dissimilar computing devices. Further, local interface may include address, control, and/or data connections to enable internal communications among the other computer components.

The processor is a hardware device for executing software, particularly software stored in memory. The processor can be any custom made or commercially available processor, such as, for example, a Core series or vPro processor made by Intel Corporation, or a Phenom, Athlon or Sempron processor made by Advanced Micro Devices, Inc. In the case where computing device is a server, the processor may be, for example, a Xeon or Itanium processor from Intel, or an Opteron-series processor from Advanced Micro Devices, Inc. Processor may also represent multiple parallel or distributed processors working in unison. Processor may also represent multiple processors located in a plurality of computing devices working in parallel, unison, or serial effort to achieve the disclosed methods.

Memory can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic magnetic, optical, and/or other types of storage media. Memory can have a distributed architecture where various components are situated remote from one another, but are still accessed by processor. These other components may reside on devices located elsewhere on a network or in a cloud arrangement.

The software in memory may include one or more separate programs. The separate programs comprise ordered listings of executable instructions for implementing logical functions. The software in memory may include the system in accordance with the invention, and a suitable operating system (O/S). Examples of suitable commercially available operating systems are Windows operating systems available from Microsoft Corporation, Mac OS X available from Apple Computer, Inc., a Unix operating system from AT&T, or a Unix-derivative such as BSD or Linux. The operating system O/S will depend on the type of computing device. For example, if the computing device is a PDA or handheld computer (e.g., smartphone), the operating system may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system essentially controls the execution of other computer programs, such as the system, and provides scheduling, input-output control, file and data management, memory management, and communication control and related services.

If computing device is a PC compatible computer, Apple® computer, a handheld device, or the like, the software in memory may further include a basic input output system (BIOS). The BIOS is a set of essential software routines that initialize and test hardware at startup, start operating system, and support the transfer of data among the hardware devices. The BIOS is stored in ROM so that the BIOS can be executed when computing device is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, Swift, and Lua.

I/O device may include input devices such as a keyboard, a mouse, a scanner, a microphone, a touch screen, a bar code reader, or an infra-red reader. It may also include output devices such as a printer, a video display, an audio speaker or headphone port or a projector. I/O device may also comprise devices that communicate with inputs or outputs, such as a short-range transceiver (RFID, Bluetooth, etc.), a telephonic interface, a cellular communication port, a router, or other types of network communication equipment. I/O device may be internal to computing device, or may be external and connected wirelessly or via connection cable, such as through a universal serial bus port.

When the computing device is in operation, processor is configured to execute software stored within memory, to communicate data to and from memory, and to generally control operations of computing device pursuant to the software. The system and operating system, in whole or in part, may be read by processor, buffered within processor, and then executed.

In the context of this document, a “computer-readable medium” may be any means that can store, communicate, propagate, or transport data objects for use by or in connection with the system. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system can be embodied in any type of computer-readable medium for use by or in connection with an instruction execution system or apparatus, such as a computer.

For purposes of connecting to other computing devices, computing device is equipped with network communication equipment and circuitry. In a preferred embodiment, the network communication equipment includes a network card such as an Ethernet card, or a wireless connection card. In a preferred network environment, each of the plurality of computing devices on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks. In certain aspects, standalone systems not requiring connectivity to other systems are also contemplated.

Disclosed are systems and methods of replacing, renewing, and/or re-activating an embedded electronic discount code within personalized digital media for redeeming at a vendor, the method including: (a) previously providing a user with personalized digital media having an embedded electronic discount code for redeeming at the vendor that was subsequently redeemed at the vendor in exchange for merchandise, wherein the personalized digital media includes at least one of a digital autograph, a personalized digital written message, a personalized audio recording, or a personalized video recording generated by a celebrity, a musician, an athlete, an author or any combination thereof having the electronic discount code embedded therein; (b) after step (a), monitoring digital activities by the user to determine participation by the user in events associated with the celebrity, the musician, the athlete, the author or any combination thereof; (c) providing a predetermined threshold for renewing the embedded electronic discount code within the personalized digital media for user participation in the events of step (b); (d) determining at predetermined time intervals whether the user met or surpassed the predetermined threshold for renewing the embedded electronic discount code within the personalized digital media of step (c); and (e) upon determining that the predetermined threshold for renewing the embedded electronic discount code was met or surpassed, automatically renewing the electronic discount code within the personalized digital media and providing the user with notification that the embedded electronic discount code has been renewed and may be redeemed at the vendor. In certain aspects, the systems and methods further comprise redeeming the electronic discount code at the vendor. In certain aspects, a third party vendor associated with and/or employed by the celebrity, musician, athlete, author or any combination can monitor the digital activities by the user and subsequently determine whether the user has met or surpassed the predetermined threshold and subsequently renew, replace, and/or re-activate the user's discount code. In this aspect, the third party vendor can also provide the celebrity, musician, athlete, author or any combination with reports either in real-time or at predetermined time intervals providing statistical analysis of the user demographics (i.e., age, geographic location, event attendance frequency, weekly/monthly/yearly expenditures of the user associated with the celebrity, musician, athlete, author or any combination) thereby allowing the celebrity, musician, athlete, author or any combination to better target users and encourage receipt of these renew, re-activated, and/or replace embedded discount codes.

In certain aspects, the embedded electronic discount code is visually displayed in the personalized digital media.

In certain aspects, the embedded electronic discount code is hidden in the personalized digital media.

In certain aspects, the embedded electronic discount code is at least one selected from the group consisting of a general bar code, a proprietary bar code, a quick response code, an audio signal, or any combination thereof.

In certain aspects, the vendor is an online retailer or brick and mortar retailer.

In certain aspects, the embedded electronic discount code is for purchasing digital media, physical merchandise, or a combination thereof

In certain aspects, the personalized digital media having an embedded electronic discount code was communicated from a database associated with the celebrity, the musician, the athlete, the author or any combination thereof to a user's personal media device selected from the group consisting of a laptop, a tablet, or a smartphone.

In certain aspects, during step (b), the database monitors user activity by communicating with the user's personal media device to subsequently determine whether the predetermined threshold for renewing the embedded electronic discount count was met or surpassed. The events associated with the celebrity, the musician, the athlete, the author or any combination thereof can include online events or live events at a specific location that are not online. In certain aspects, the events associated with the musician, the athlete, the author or any combination thereof comprise online events, live events at a specific location, or a combination thereof. Furthermore, examples of predetermined thresholds of steps (c) and (d) include, but are not limited to, a musician who rewards a fan for attending multiple shows in a row on a tour. Such a fan (user) might attend concerts in several cities, wherein the artist rewards their loyalty and increased spending in attending multiple events over a short time period. Alternatively, an author might reward a new fan who initially purchases the fourth book in a series at a book signing, who subsequently purchases the prior three books published previously. The fan, having purchased the entire series, could be offered a discount or giveaway for the upcoming fifth book to be published in the future. In yet another example, a professional athlete who is traded from one team to another might offer fans who received autographed digital memorabilia a discount to purchase themed merchandise featuring his new team. This allows the athlete to retain fans over multiple team moves throughout the course of his or her career.

The following reference numerals are used to indicate the parts and environment of the systems and methods as depicted in the figures:

1—A database that issues and archives a new one-time code (embedded electronic discount code).

2—A one-time use code embedded in the personalized digital media and adapted for reactivation, renewing, and/or replacement with, for example, another one-time use code.

3—A fan's (user) digital media device (cell phone, tablet, eReader, PC, etc.).

4—Personalized digital media a fan received in the past from a celebrity (musician, athlete, author, etc.) including the one-time code.

5—A retail merchant (vendor—online vendor, brick and mortar vendor, or a combination thereof).

6—A database that confirms the one-time code's validity. (In certain aspects, database 1 and 6 can be the same database.)

7—Free or discounted digital media delivered to the fan's media device.

8—Physical merchandise presented to the fan in person or shipped to their address upon successful use of the new one-time code.

9—Media Device and database communicating regarding fan's participation in event(s) associated with the celebrity to determine whether a predetermined threshold for renewing the one-time code.

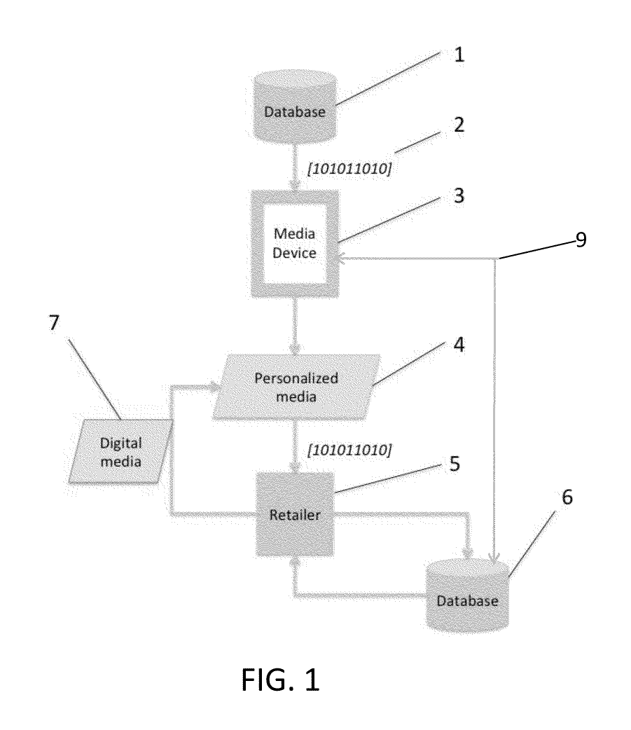

Referring to FIG. 1, a means for delivering a new or renewed one-time code over a network (Internet or other network) to an electronic reading and storage device. A database component 1 provides a new or renewed one-time use code 2 to a fan's digital media device 3 due to previously received personalized digital media 4 from a celebrity to a fan. The one time code is presented to a retailer 5 who confirms the codes validity through a database 6 (that may or may not be the same database that created the code). Upon confirmation of the code's validity the retailer provides downloaded or streamed digital media 7 to the fan's media device.

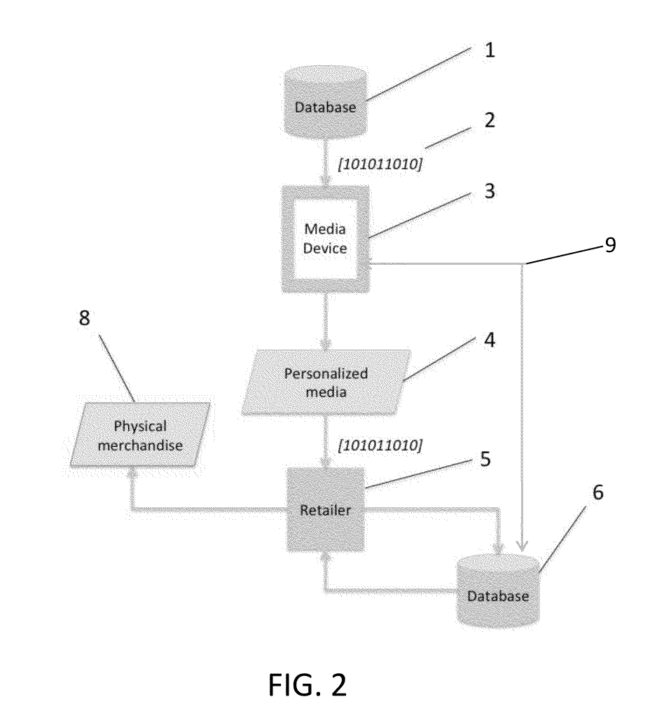

Referring to FIG. 2, the personalized digital media is delivered at the time of purchase. A database component 1 provides a new or renewed one-time use code 2 to a fan's digital media device 3 due to previously received personalized digital media 4 from a celebrity to a fan. The one time code is presented to a retailer 5 who confirms the codes validity through a database 6 (that may or may not be the same database that created the code). Upon confirmation of the code's validity the retailer provides the physical merchandise 8 in person or ship/mail it to the fan's address of choice.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A method of renewing an embedded electronic discount code within personalized digital media for redeeming at a vendor, the method comprising:
(a) previously providing a user with personalized digital media having an embedded electronic discount code for redeeming at the vendor that was subsequently redeemed at the vendor in exchange for merchandise, wherein the personalized digital media includes at least one of a digital autograph, a personalized digital written message, a personalized audio recording, or a personalized video recording generated by a celebrity, a musician, an athlete, an author or any combination thereof having the electronic discount code embedded therein;
(b) after step (a), monitoring digital activities by the user to determine participation by the user in events associated with the celebrity, the musician, the athlete, the author or any combination thereof;
(c) providing a predetermined threshold for renewing the embedded electronic discount code within the personalized digital media for user participation in the events of step (b);
(d) determining at predetermined time intervals whether the user met or surpassed the predetermined threshold for renewing the embedded electronic discount code within the personalized digital media of step (c); and
(e) upon determining that the predetermined threshold for renewing the embedded electronic discount code was met or surpassed, automatically renewing the electronic discount code within the personalized digital media and providing the user with notification that the embedded electronic discount code has been renewed and may be redeemed at the vendor.

2. The method of claim 1, further comprising redeeming the electronic discount code at the vendor.

3. The method of claim 1, wherein the embedded electronic discount code is visually displayed in the personalized digital media.

4. The method of claim 1, wherein the embedded electronic discount code is hidden in the personalized digital media.

5. The method of claim 1, wherein the embedded electronic discount code is at least one selected from the group consisting of a general bar code, a proprietary bar code, a quick response code, an audio signal, or any combination thereof.

6. The method of claim 1, wherein the vendor is an online retailer or brick and mortar retailer.

7. The method of claim 1, wherein embedded electronic discount code is for purchasing digital media, physical merchandise, or a combination thereof.

8. The method of claim 1, wherein the personalized digital media having an embedded electronic discount code was communicated from a database associated with the celebrity, the musician, the athlete, the author or any combination thereof to a user's personal media device selected from the group consisting of a laptop, a tablet, or a smartphone.

9. The method of claim 8, wherein during step (b) the database monitors user activity by communicating with the user's personal media device to subsequently determine whether the predetermined threshold for renewing the embedded electronic discount count was met or surpassed.

10. The method of claim 1, wherein the events associated with the celebrity, the musician, the athlete, the author or any combination thereof comprise online events or live events at a specific location that are not online.

11. The method of claim 1, wherein the events associated with the musician, the athlete, the author or any combination thereof comprise online events, live events at a specific location, or a combination thereof.
